(19) United States
(12) Patent Application Publication
(10) Pub. No.: US 2005/0218089 A1
(43) Pub. Date: Oct. 6, 2005

(54) FLUSHING AND FILTERING SYSTEM FOR ELECTROEROSION MACHINING

(75) Inventors: Bin Wei, Mechanicville, NY (US); Michael Scott Lamphere, Hooksett, NH (US); Renwei Yuan, Shanghai, Shanghai (CN); Andy Ji, Shanghai, Shanghai (CN)

Correspondence Address: CANTOR COLBURN, LLP, 55 GRIFFIN ROAD SOUTH, BLOOMFIELD, CT, 06002, US

(73) Assignee: GENERAL ELECTRIC COMPANY, Schenectady, NY (US)

(21) Appl. No.: 10/708,879

(22) Filed: Mar. 30, 2004

(51) Int. Cl. B01D 36/00

(52) U.S. Cl. 210/805; 210/806; 210/167; 210/171

(57) ABSTRACT

A flushing and filtering system for an electroerosion machine includes a work tank configured to maintain a workpiece therein, a first filtering stage for roughly filtering residue-containing machining liquid exiting from the work tank, and a second filtering stage for finely filtering roughly-filtered machining liquid exiting from the first filtering stage.

### BACKGROUND OF THE INVENTION

The present disclosure relates generally to electroerosion machines and, more particularly, to a flushing and filtering system for electroerosion machines.

Electroerosion machining is a process in which an electrically conductive metal workpiece is shaped by removing material through melting or vaporization by electrical sparks and arcs. The spark discharge and transient arc sare produced by applying controlled direct current between the workpiece (typically anodic or positively charged) and the tool or electrode (typically the cathode or negatively charged). The end of the electrode and the workpiece are separated by a spark gap from about 0.01 millimeters to about 0.50 millimeters, and are immersed in or flooded by a dielectric fluid or an electrolyte fluid. The fluid in the gap is partially ionized under the DC voltage (pulsed or continuous), thus enabling a spark discharge charge or transient arc to pass between the tool and the workpiece. Each spark and/or arc produces enough heat to melt or vaporize a small quantity of the workpiece, thereby leaving a tiny pit or crater in the work surface.

Electroerosion machining is also non-contact or minimum-contact machining process that can quickly shape any electrically conductive material regardless of the hardness or toughness of the material. In the electroerosion process, a substantial amount of material is removed from the metal workpiece. Metal chips are deposited at the bottom of a working tank and subsequently rolled by high pressure flushing. Without adequate filtration, these rolled chips can be pumped back into the machining zone and generate secondary discharge or arcing between the electrode and the workpiece,thereby affecting process stability and surface integrity as well as geometry accuracy.

At present, existing EDM-type filtration and flushing systems that are adopted for electroerosion machines do not have sufficient filtration systems associated therewith.

### BRIEF DESCRIPTION OF THE INVENTION

The above discussed and other drawbacks and deficiencies of the prior art are overcome or alleviated by a flushing and filtering system for an electroerosion machine. In an exemplary embodiment, the system includes a work tank configured to maintain a workpiece therein, a first filtering stage for roughly filtering residue-containing machining liquid exiting from the work tank, and a second filtering stage for finely filtering roughly-filtered machining liquid exiting from the first filtering stage.

In another aspect, a method for flushing and filtering an electroerosion machine includes passing a residue-containing machining liquid through a first filtering stage for roughly filtering the residue-containing machining liquid. The residue-containing liquid exits from a work tank configured to maintain a workpiece therein. The roughly-filtered machining liquid exiting from the first filtering stage is passed into a second filtering stage for fine filtering of the roughly-filtered machining liquid.

### BRIEF DESCRIPTION OF THE DRAWINGS

Referring to the exemplary drawings wherein like elements are numbered alike in the several Figures:

FIG. 1 is schematic diagram of a flushing and filtering system suitable for use with electroerosion machines, in accordance with an embodiment of the invention; and

FIG. 2 is schematic diagram of and alternative embodiment of the flushing and filtering system shown in FIG. 1.

### DETAILED DESCRIPTION OF THE INVENTION

Disclosed herein is a novel flushing and filtering system for electroerosion machines, in which two separate filtering stages (“rough” and “fine”) are implemented. Each filtering stage has a separate filtering tank associated therewith, and a pump to transfer the roughly filtered machining fluid to the fine filtering tank from the rough filtering tank. Moreover, the fine filtered stage further features two fluid return paths, including an additional fluid adding pump in addition to a high-pressure pump for fluid return directly to the tool itself.

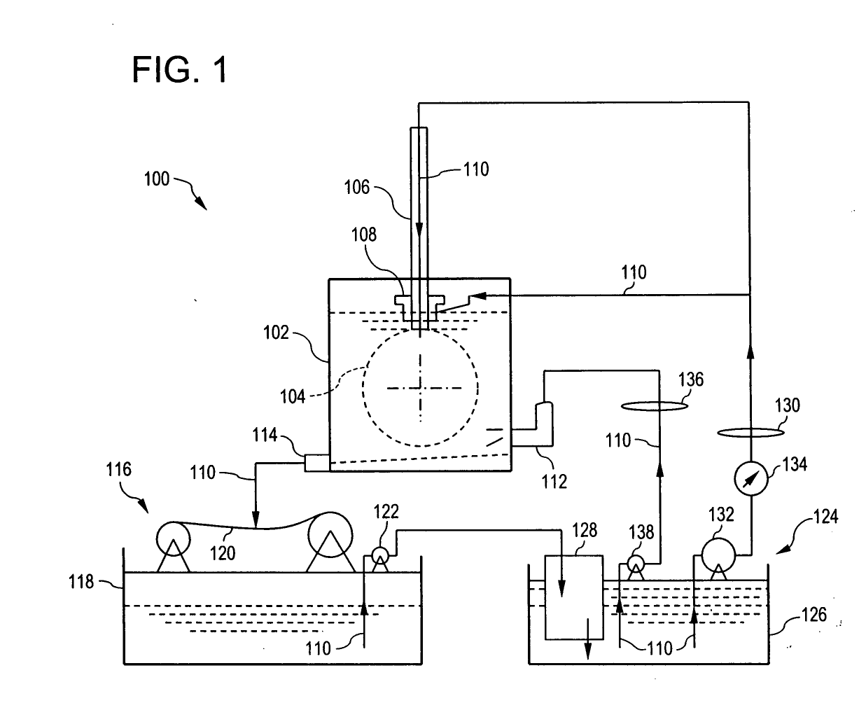

Referring now to FIG. 1, there is shown a schematic diagram of a flushing and filtering system 100 suitable for use for electroerosion machines, in accordance with an embodiment of the invention. As is shown, a work tank 102 contains workpiece 104 that is to be milled, shaped or otherwise machined by an electroerosion process. To this end, an electrode 106 is configured in close proximity to the workpiece 104 through a guide bush 108. As is known in the art, the electrode 106 has a machining liquid 110 continuously circulated at high pressure therethrough and introduced into a gap between the electrode 106 and the workpiece 104 for facilitating the machining operation.

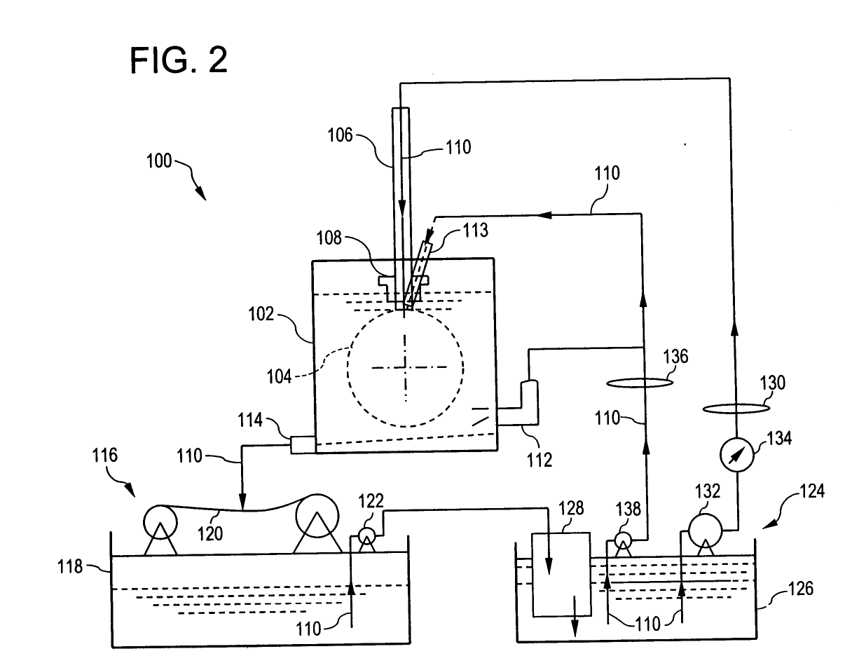

In addition to being circulated through the electrode center, the machining liquid 110 is also supplied to the guide bush for exterior flushing of contaminants. A liquid adding inlet 112 at the lower portion of the work tank 102 receives machining liquid 110 from a separate input path from that supplying the electrode 106 and guide bush 108, as described in greater detail hereinafter. Sufficient machining liquid 110 is introduced into the work tank 102 to as to maintain the workpiece 104 and guide bush 108 in a substantially submerged condition during the machining process. In an alternative embodiment depicted in FIG. 2, a liquid adding outlet/nozzle 113 is configured proximate the top of the work tank 102 for receiving machining liquid 110 and spraying or flushing the machining liquid 110 to the machining area from an up-down or side-to-side direction between the workpiece 104 and electrode 106. In other words, in lieu of being submerged in machining liquid 110, the nozzle may be used to spray the exterior of the guide bush 108 and the workpiece 104.

In either case, the residue-containing machining liquid 110 exits the bottom of the work tank 102 from outlet 114, and is directed to a first (rough) filtering stage, generally designated at 116. In order to facilitate the sweeping away of metallic chip residue, the bottom of the work tank 102 may be downwardly sloped or inclined toward outlet 114. The first filtering stage 116 includes a first (rough) filtering tank 118, rough filtering device 120 and a rough filtering pump 122 for transferring the resulting roughly filtered machining liquid 110 to a second (fine) filtering stage 124.

The second filtering stage 124 includes a second (fine) filtering tank 126 in which there is included a fine filtering device 128 for receiving the roughly filtered machining liquid 110 from the first filtering stage 116. Two separate exit fluid return paths are used to transfer the resulting finely filtered machining liquid back through the tool electrode 106 and into the work tank 102. A first fluid return path is a high-pressure fluid path 130 that includes a high-pressure pump 132 and optional pressure sensor 134 for circulating the finely filtered machining liquid 110 through the electrode 106 and to the guide bush 108. A second fluid return path 136 includes a liquid adding pump 138 that supplies finely filtered machining liquid 110 through the liquid adding inlet 112 at the lower portion of the work tank 102.

In operation of the flushing and filtering system 100, the liquid adding pump 138 is turned on to add finely filtered machining fluid (e.g., dielectric, electrolyte) into the work tank 102. When both the workpiece 104 and the guide bush 108 are submerged into the machining fluid 110, the high pressure pump 132 is turned on, and the normal electroerosion machining cycle starts. At the same time, the outlet 114 is opened while the rough filtering pump 122 between the rough and fine filtering tanks is turned on, causing the system 100 to begin the flushing and filtering cycle. During machining of the workpiece 104, the resulting metallic chips are swept away from the workpiece 104 and out of the work tank 102 due to the sloped bottom surface of the work tank 102 and continuous addition of machining fluid 110 through at least two different fluid paths. This also helps to ensure each workpiece is machined under the same conditions, as well as to reduce secondary discharge by the chips. Thus, both process stability and part quality is improved.

While the invention has been described with reference to a preferred embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

1. A flushing and filtering system for an electroerosion machine, comprising:
a work tank configured to maintain a workpiece therein;
a first filtering stage for roughly filtering residue-containing machining liquid exiting from said work tank; and
a second filtering stage for finely filtering roughly-filtered machining liquid exiting from said first filtering stage.

2. The flushing and filtering system of claim 1, further comprising:
a first fluid return path to said work tank, said first fluid return path comprising a high-pressure return path for introducing finely-filtered machining fluid through an electrode included in the electroerosion machine; and
a second fluid return path to said work tank, said second fluid return path introducing said finely-filtered machining fluid through a liquid adding inlet disposed at a lower portion of said work tank.

3. The flushing and filtering system of claim 2, wherein said first filtering stage further comprises:
a rough filtering device for receiving residue-containing machining liquid exiting from said work tank;
a first filtering tank for holding said roughly-filtered machining liquid passed through said rough filtering device; and
a rough filtering pump for transferring said roughly-filtered machining liquid from said first filtering tank to said second filtering stage.

4. The flushing and filtering system of claim 3, wherein said second filtering stage further comprises:
a fine filtering device for receiving said roughly-filtered machining liquid transferred from said first filtering tank;
a fine filtering tank for holding said finely-filtered machining liquid passed through said fine filtering device;
a high-pressure pump for supplying said finely filtered machining liquid through said first fluid return path; and
a liquid-adding pump for supplying said finely filtered machining liquid through said second fluid return path.

5. The flushing and filtering system of claim 2, wherein said first fluid return path is further configured so as to provide said finely filtered machining liquid to a guide bush, said guide bush having an end of said electrode disposed therethrough.

6. The flushing and filtering system of claim 2, wherein a bottom surface of said work tank is sloped so as to cause said residue-containing machining liquid to run toward an outlet proximate the bottom of said work tank.

7. The flushing and filtering system of claim 1, wherein said machining liquid is a dielectric material.

8. The flushing and filtering system of claim 1, wherein said machining liquid is an electrolyte material.

9. The flushing and filtering system of claim 4, further comprising a pressure sensor within said first fluid return path.

10. The flushing and filtering system of claim 1, wherein said work tank is configured to keep said workpiece completely submerged within said machining fluid.

11. The flushing and filtering system of claim 5, wherein work tank is further configured to spray machining fluid on exterior surfaces of said guide bush and said workpiece.

12. The flushing and filtering system of claim 11, further comprising a nozzle configured for spraying machining fluid on said exterior surfaces of said guide bush and said workpiece, said nozzle included within said second fluid return path.

13. A method for flushing and filtering an electroerosion machine, comprising:
passing a residue-containing machining liquid through a first filtering stage for roughly filtering said residue-containing machining liquid, said residue-containing liquid exiting from a work tank configured to maintain a workpiece therein; and
passing roughly-filtered machining liquid exiting from said first filtering stage into a second filtering stage for fine filtering of said roughly-filtered machining liquid.

14. The method of claim 13, further comprising:
returning finely-filtered machining fluid to said work tank through a first fluid return path, said first fluid return path comprising a high-pressure return path for introducing said finely-filtered machining fluid through an electrode included in the electroerosion machine; and
returning said finely-filtered machining fluid to said work tank through a second fluid return path, said second fluid return path introducing said finely-filtered machining fluid through a liquid adding inlet disposed at a lower portion of said work tank.

15. The method of claim 14, wherein said first filtering stage further comprises:
a rough filtering device for receiving residue-containing machining liquid exiting from said work tank;
a first filtering tank for holding said roughly-filtered machining liquid passed through said rough filtering device; and
a rough filtering pump for transferring said roughly-filtered machining liquid from said first filtering tank to said second filtering stage.

16. The method of claim 15, wherein said second filtering stage further comprises:
a fine filtering device for receiving said roughly-filtered machining liquid transferred from said first filtering tank;
a fine filtering tank for holding said finely-filtered machining liquid passed through said fine filtering device;
a high-pressure pump for supplying said finely filtered machining liquid through said first fluid return path; and
a liquid-adding pump for supplying said finely filtered machining liquid through said second fluid return path.

17. The method of claim 14, wherein said first fluid return path is further configured so as to provide said finely filtered machining liquid to a guide bush, said guide bush having an end of said electrode disposed therethrough.

18. The method of claim 14, wherein a bottom surface of said work tank is sloped so as to cause said residue-containing machining liquid to run toward an outlet proximate the bottom of said work tank.

19. The method of claim 13, wherein the electroerosion machine includes a dielectric material passed through a gap between the tool electrode and workpiece.

20. The method of claim 13, wherein the electroerosion machine includes an electrolyte passed through a gap between the tool electrode and workpiece.

21. The method of claim 16, further comprising a pressure sensor within said first fluid return path.

22. The method of claim 13, wherein said work tank is configured to keep said workpiece completely sub-merged within said machining fluid.

23. The method of claim 13, wherein said work tank is further configured to spray machining fluid on exterior surfaces of said guide bush and said workpiece.

24. The method of claim 23, further comprising spraying said machining fluid on said exterior surfaces of said guide bush and said workpiece through a nozzle, said nozzle included within said second fluid return path.
